(19) United States
(12) Patent Application Publication
(10) Pub. No.: US 2020/0218097 A1
(43) Pub. Date: Jul. 9, 2020

(54) OPTICAL MODULATOR AND OPTICAL MODULE

(71) Applicant: FUJITSU LIMITED, Kawasaki-shi (JP)

(72) Inventor: Hirotomo Izumi, Kawasaki (JP)

(73) Assignee: FUJITSU LIMITED, Kawasaki-shi (JP)

(21) Appl. No.: 16/720,075

(22) Filed: Dec. 19, 2019

(30) Foreign Application Priority Data
Jan. 7, 2019 (JP) 2019-000457

(51) Int. Cl. G02F 1/01

(52) U.S. Cl. CPC G02F 1/0121; G02F 2203/50; G02F 1/011

(57) ABSTRACT

An optical modulator includes a first optical waveguide dividing light input thereto, first and second diodes shifting phases of light beams as a result of the division of the light by the optical waveguide, a second optical waveguide causing the light beams passing through the first and second diodes to interfere, a control circuit adjusting at least one of a current flowing in the first diode and a current flowing in the second diode to control a phase difference of the light beams interfering in the second optical waveguide, and an electrical resistance element having one end coupled to the first and second diodes and the other end grounded.

### CROSS-REFERENCE TO RELATED APPLICATION

This application is based upon and claims the benefit of priority of the prior Japanese Patent Application No. 2019-457, filed on Jan. 7, 2019, the entire contents of which are incorporated herein by reference.

### FIELD

The embodiments discussed herein are related to an optical modulator and an optical module.

### BACKGROUND

In the past, in order to convert an electric signal to an optical signal, an external modulation method has been known in which output light from a semiconductor laser is externally modulated. For example, a mach-zehnder modulator has been known in which laser light is divided into two optical waveguides, and a phase difference is given to the divided light beams which are then merged. In the past, a configuration using phase shifters in a modulator formed by using a silicon substrate has been known, wherein the phase shifters shift the phases of light beams by feeding current to diodes provided on optical waveguides on the silicon substrate.

Related art is disclosed in, for example, Japanese Laid-open Patent Publication No. 2-239223.

### SUMMARY

According to an aspect of the embodiments, an optical modulator includes a first optical waveguide dividing light input thereto, first and second diodes shifting phases of light beams as a result of the division of the light by the optical waveguide, a second optical waveguide causing the light beams passing through the first and second diodes to interfere, a control circuit adjusting at least one of a current flowing in the first diode and a current flowing in the second diode to control a phase difference of the light beams interfering in the second optical waveguide, and an electrical resistance element having one end coupled to the first and second diodes and the other end grounded.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of an optical modulator and an optical module according to an embodiment;

FIG. 2 is a diagram illustrating another example of an optical modulator and an optical module according to the embodiment;

FIG. 3 is a diagram illustrating an example of phase modulation by diodes according to the embodiment;

FIG. 4 is a diagram illustrating another example of phase modulation by diodes according to the embodiment;

FIG. 5 is a first diagram illustrating an example of a decrease in phase shift amount and a decrease in amplitude caused by an increase of current flowing in a diode;

FIG. 6 is a second diagram illustrating an example of a decrease in phase shift amount and a decrease in amplitude caused by an increase of current flowing in a diode;

FIG. 7 is a graph illustrating an example of a relationship between current flowing in a diode and phase shift amounts and optical losses;

FIG. 8 is a diagram illustrating an example of an operation of the optical modulator according to the embodiment;

FIG. 9 is a graph illustrating an example of currents flowing in diodes in the optical modulator according to the embodiment;

FIG. 10 is a graph illustrating an example of phase shift amounts given to the light beams by the diodes in the optical modulator according to the embodiment;

FIG. 11 is a graph illustrating an example of phase differences given to the light beams by the diodes in the optical modulator according to the embodiment;

FIG. 12 is a diagram illustrating examples of diode settings by an optical modulator according to the embodiment;

FIG. 13 is a first graph illustrating an example of a control step current characteristic for each resistance value of a phase adjustment resistance according to the embodiment;

FIG. 14 is a second graph illustrating an example of a control step-current characteristic for each resistance value of the phase adjustment resistance according to the embodiment;

FIG. 15 is a third graph illustrating an example of a control step-current characteristic for each resistance value of the phase adjustment resistance according to the embodiment; and

FIG. 16 is a fourth graph illustrating an example of a control step-current characteristic for each resistance value of the phase adjustment resistance according to the embodiment.

### DESCRIPTION OF EMBODIMENTS

In a phase shifter that shifts a phase of light by feeding current to a diode, as the amount of current to be fed to the diode increases, the amount of change of the phase shift amount decreases against the amount of change of the current to be fed to the diode. For that, in the technology in the past, in accordance with an environmental change or aged deterioration, for example, the amount of current to be fed to the diode is acceleratingly increased to acquire a required phase shift amount when the operating point of the modulator is moved in the direction for increasing the phase shift amount. The power required for the phase modulation disadvantageously increases.

According to one aspect, it is an object of the present disclosure to provide an optical modulator and an optical module that may reduce the power required for phase modulation.

Hereinafter, embodiments of an optical modulator and an optical module according to the present disclosure will be described in detail with reference to drawings.

### Optical Modulator and Optical Module according to Embodiment

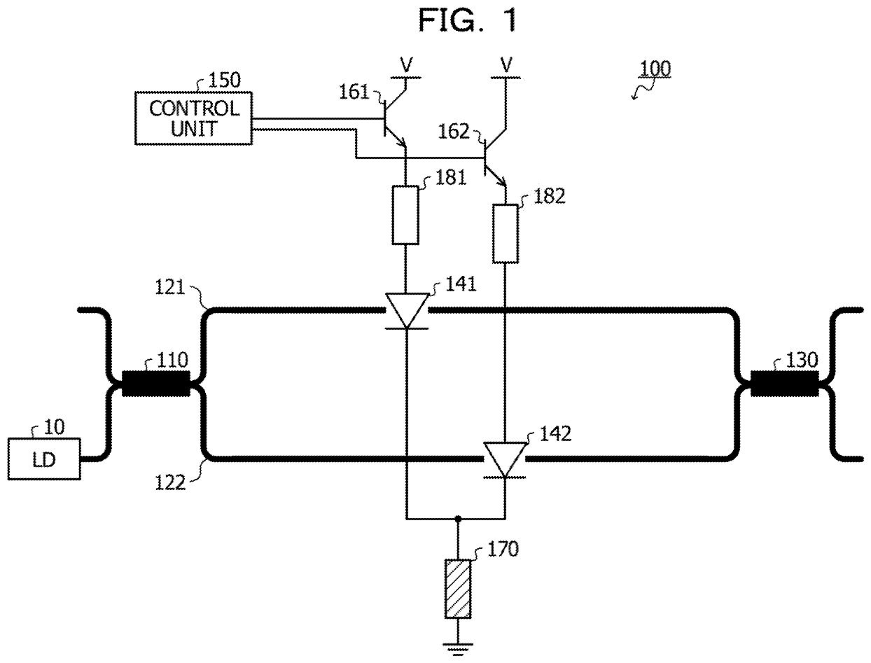

FIG. 1 is a diagram illustrating an example of an optical modulator and an optical module according to an embodiment. The optical module according to the embodiment illustrated in FIG. 1 includes a laser diode (LD) 10 and an optical modulator 100. The LD 10 generates light and outputs it to the optical modulator 100. The light to be output from the LD 10 is continuous light, for example.

The optical modulator 100 according to this embodiment generates an optical signal by performing intensity modulation on the light output from the LD 10. For example, the optical modulator 100 is a silicon type modulator that is formed by using a silicon substrate (silicon photonics chip).

For example, the optical modulator 100 includes a branch unit 110, parallel waveguides 121 and 122 and an interference unit 130. The branch unit 110, the parallel waveguides 121 and 122 and the interference unit 130 are, for example, optical waveguides formed on the silicon substrate. The optical modulator 100 further includes diodes 141 and 142, a control unit 150, transistors 161 and 162, a phase adjustment resistance 170, and detection resistances 181 and 182.

The branch unit 110 divides light output from the LD 10 and outputs one of the divided light beams to the parallel waveguide 121 and outputs the other one, of the divided light beams to the parallel waveguide 122. The branch unit 110 is implemented by a 2-input, 2-output optical coupler as an example.

The parallel waveguides 121 and 122 are provided in parallel with each other and allow the light beams output from the branch unit 110 to pass through and output them to the interference unit 130. The parallel waveguides 121 and 122 have substantially equal optical path lengths, but the optical path lengths may slightly differ because of a manufacturing error, aged deterioration or the like. Hereinafter, a configuration relating to the parallel waveguide 121 will be called an upper side configuration, and a configuration relating to the parallel waveguide 122 will be called a lower side configuration.

The interference unit 130 causes the light beams output from the parallel waveguides 121 and 122 to interfere and outputs the light beams acquired by the interference. The interference unit 130 is implemented by a 2-input, 2-output optical coupler as an example.

The diodes 141 and 142 are phase shifters formed by providing pn junctions on the silicon substrate of the optical modulator 100, for example. For example, the diode 141 has an anode coupled to an emitter of the transistor 161 and a cathode coupled to the phase adjustment resistance 170. The diode 142 has an anode coupled to an emitter of the transistor 162 and a cathode coupled to the phase adjustment resistance 170.

The refractive indices of the diodes 141 and 142 change due to the carrier plasma effect in accordance with the current flowing in the diodes 141 and 142 formed on the silicon substrate so that light beams passing through the diodes 141 and 142 may be phase-modulated. The diodes 141 and 142 are p-intrinsic n (PIN) diodes, for example.

The diode 141 is an upper side phase shifter provided in the parallel waveguide 121 and phase-modulates a light beam passing through the parallel waveguide 121 (diode 141) in accordance with the current fed from the transistor 161. The diode 142 is a lower side phase shifter provided in the parallel waveguide 122 and phase-modulates a light beam passing through the parallel waveguide 122 (diode 142) in accordance with the current fed from the transistor 162.

The control unit 150 controls the phase modulation to be performed on the light beams in the diodes 141 and 142. For example, the control unit 150 applies current to the base of the transistor 161 to control the current to be applied to the base of the transistor 161 so that the current fed from the transistor 161 to the diode 141 is adjusted. Thus, the phase shift amount of the light in the diode 141 may be controlled.

The control unit 150 applies current to the base of the transistor 162 to control the current to be applied to the base of the transistor 162 so that the current fed from the transistor 162 to the diode 142 is adjusted. Thus, the phase shift amount of the light in the diode 142 may be controlled,

In other words, for example, the control unit 150 may control the phase differences of the light beams passing through the diodes 141 and 142 by controlling the current to be applied to the bases of the transistors 161 and 162. The control of the phase differences of the light beams passing through the diodes 141 and 142 controls the intensities of the light beams to be output from the interference unit 130 so that the light output from the LD 10 may be intensity-modulated.

The transistor 161 has the base coupled to the control unit 150, a collector coupled to a voltage source V and an emitter coupled to the diode 141 through the detection resistance 181. In the transistor 161, current flows from the collector to the emitter in accordance with the current applied from the control unit 150 to the base, and the flowing current is applied to the diode 141. In other words, for example, the part that drives the diode 141 is an emitter follower circuit having the collector of the transistor 161 as a common terminal, the base of the transistor 161 as an input terminal and the emitter of the transistor 161 as an output terminal,

The transistor 162 has the base coupled to the control unit 150, a collector coupled to a voltage source V and an emitter coupled to the diode 142 through the detection resistance 182. In the transistor 162, current flows from the collector to the emitter in accordance with the current applied from the control unit 150 to the base, and the flowing current is applied to the diode 142. In other words, for example, the part that drives the diode 142 is an emitter follower circuit having the collector of the transistor 162 as a common terminal, the base of the transistor 162 as an input terminal and the emitter of the transistor 162 as an output terminal.

The phase adjustment resistance 170 is an electrical resistance element (resistor) having one end coupled to the cathodes of the diodes 141 and 142 and the other end grounded. The phase adjustment resistance 170 is provided that is commonly coupled to the cathodes of the diodes 141 and 142 (or the output terminals of the two emitter follower circuits). In other words, for example, the diodes 141 and 142 are mounted on the output sides of the emitter follower circuits serially with the phase adjustment resistance 170, and the phase adjustment resistance 170 is used by both of the diodes 141 and 142,

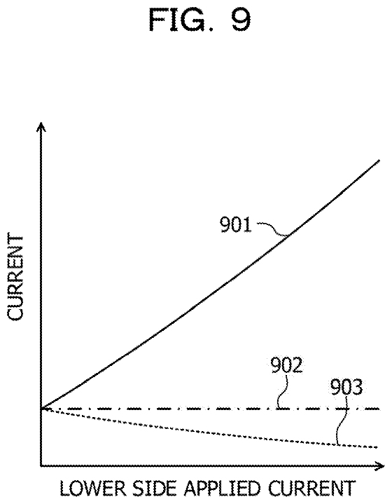

When, for example, the current applied to the base of the transistor 162 increases, the current flowing in the diode 142 increases, and the current flowing in the diode 141 decreases. The effects of the provision of the phase adjustment resistance 170 will be described below (with reference to FIGS. 9 to 12, for example).

The detection resistance 181 is a resistance that detects current flowing from the transistor 161 to the diode 141. For example, the voltage value between the detection resistance 181 and the diode 141 is measured, and the current flowing from the transistor 161 to the diode 141 may be detected based on the measured voltage value and a known resistance value of the detection resistance 181. Also, the detection resistance 182 is a resistance that detects current flowing from the transistor 162 to the diode 142.

The results of the current detection by using the detection resistances 181 and 182 are fed back to the control unit 150, for example. Based on the results of the current detection by using the detection resistances 181 and 182, the control unit 150 controls current to be applied to the transistors 161 and 162 such that excessive current does not flow to the diodes 141 and 142. Based on the results of the current detection by using the detection resistances 181 and 182, the control unit 150 controls current to be applied to the transistors 161 and 162 such that too little current does not flow to the diodes 141 and 142. However, the detection resistances 181 and 182 may be omitted in the configuration of the optical modulator 100.

### Another Example of Optical Modulator and Optical Module according to Embodiment

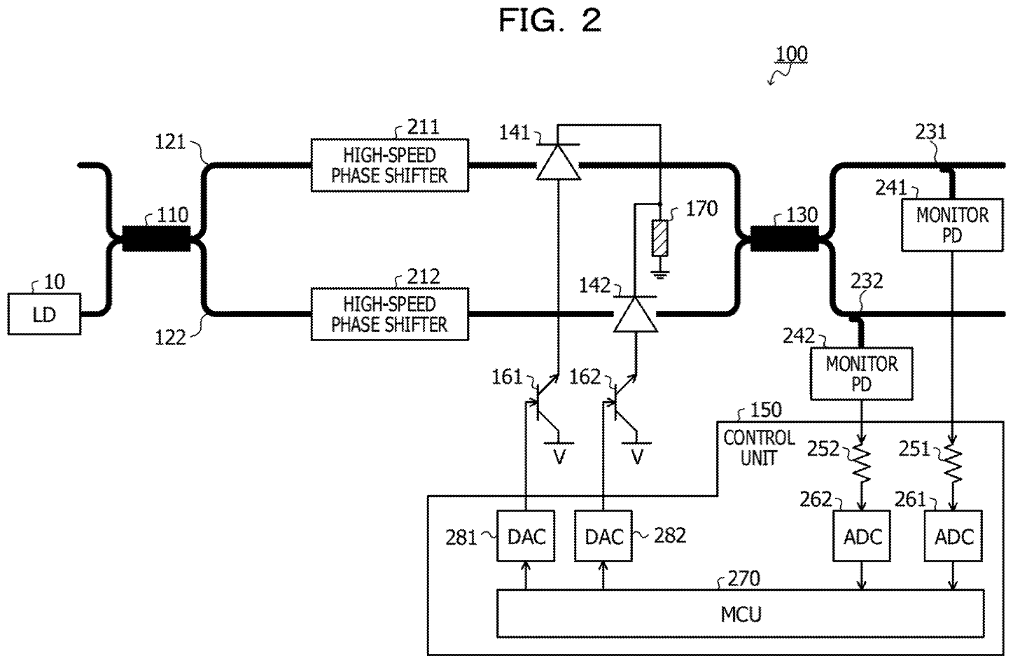

FIG. 2 is a diagram illustrating another example of an optical modulator and an optical module according to the embodiment. In FIG. 2, the same portions as those illustrated in FIG. 1 are denoted by the same reference signs and descriptions thereof will be omitted. As illustrated in FIG. 2, the optical modulator 100 according to the embodiment may further include high-speed phase shifters 211 and 212, branch units 231 and 232 and monitor photo detectors (PDs) 241 and 242 in addition to the configuration illustrated in FIG. 1. The detection resistances 181 and 182 illustrated in FIG. 1 are not illustrated in FIG. 2.

The high-speed phase shifters 211 and 212 are diodes formed by providing pn junctions on the silicon substrate of the optical modulator 100, like the diodes 141 and 142, for example. The high-speed phase shifters 211 and 212 are data modulating units that are provided in the parallel waveguides 121 and 122, respectively, and that perform phase-modulation on light beams passing through the parallel waveguides 121 and 122, respectively, in accordance with a data signal input from a driving circuit, not illustrated. The high-speed phase shifters 211 and 212 operate at a higher speed than the diodes 141 and 142, for example, such that phase modulation based on a high-speed data signal may be performed.

On the other hand, the diodes 141 and 142 are phase shifters that operate at a lower speed than the high-speed phase shifters 211 and 212 to adjust the modulation operating point of the optical modulator 100. The modulation operating point of the optical modulator 100 is a phase difference of light beams passing through the parallel waveguides 121 and 122 in a case where the high-speed phase shifters 211 and 212 do not perform modulation based on a data signal. Alternatively, the modulation operating point of the optical modulator 100 is the center (mean value) of the range of changes of the phase difference of light beams passing through the parallel waveguides 121 and 122 when the high-speed phase shifters 211 and 212 perform modulation based on a data signal.

Like the branch unit 110, the parallel waveguides 121 and 122 and, the interference unit 130, the branch units 231 and 232 are, for example, optical waveguides formed on the silicon substrate. The interference unit 130 outputs one of the light beams acquired by an interference to the branch unit 231 and outputs the other one of the light beams acquired by the interference to the branch unit 232.

The branch unit 231 divides light output from the interference unit 130 and outputs one of the divided light beams to the subsequent stage of the optical modulator 100 and outputs the other one of the divided light beams to the monitor PD 241. The branch unit 232 divides light output from the interference unit 130 and outputs one of the divided light beams to the subsequent stage of the optical modulator 100 and outputs the other one of the divided light beams to the monitor PD 242.

Each of the branch units 231 and 232 may be implemented by, for example, outputting a part of light output from the interference unit 130 to the monitor PDs 241 and 242 by using an optical coupler and allowing the remaining light to pass through to output the light to the subsequent stage of the optical modulator 100. The optical coupler may have a branching ratio of 90:10 or 95:5, for example. The light to be output to the subsequent stage of the optical modulator 100 may be any one of the light beams output from the branch units 231 and 232.

The monitor PDs 241 and 242 convert light beams output from the branch units 231 and 232, respectively, to electric signals and output the converted electric signals to the control unit 150. The monitor PDs 241 and 242 operate at a lower speed than the rate of data signals input to the high-speed phase shifters 211 and 212, for example. Thus, even while the high-speed phase shifters 211 and 212 are being driven, the monitor PDs 241 and 242 may measure the mean value of the optical output power of the optical modulator 100, that is, the optical output power of the optical modulator 100 at the modulation operating point.

The control unit 150 controls phase shift amounts of the light beams in the diodes 141 and 142 based on the electric signals output from the monitor PDs 241 and 242. For example, the control unit 150 determines the magnitudes and directions of the phase deviations of the light beams that interfere in the interference unit 130 based on the electric signals output from the monitor PDs 241 and 242 and controls the phase shift amounts of the light beams so as to correct the phase deviations.

The phase deviations are deviations from optimum phase states of the phases of the light beams passing through the parallel waveguides 121 and 122 and, for example, are deviations from optimum points of the modulation operating points described above. The correction of the phase deviations is reduction of the phase deviations (or brings the modulation operating points to optimum points). For example, the control unit 150 controls phase shift amounts of the light beams in the diodes 141 and 142 such that the difference in power between the light beams indicated by the electric signals output from the monitor PDs 241 and 242 may be reduced.

For example, the control unit 150 has resistances 251 and 252, analog/digital converters (ADCs) 261 and 262, a micro control unit (MCU) 270, and digital/analog converters (DACs) 281 and 282. The resistances 251 and 252 convert electric signals output from the monitor PDs 241 and 242, respectively, from current signals to voltage signals. The resistances 251 and 252 output the converted electric signals to the ADCs 261 and 262, respectively. The electric signal output from the resistance 251 to the ADC 261 is a signal indicating by voltage the optical power in the upper side branch unit 231. The electric signal output from the resistance 252 to the ADC 262 is a signal indicating by voltage the optical power in the lower side branch unit 232.

ADCs 261 and 262 convert electric signals output from the resistances 251 and 252 from analog signals to digital signals. The ADC 261 outputs the converted electric signal to the MCU 270 as optical power information indicating an optical power. The ADC 262 outputs the converted electric signal to the MCU 270 as optical power information indicating an optical power.

The MCU 270 outputs digital current information indicating current to be applied to the bases of the transistors 161 and 162 to the DACs 281 and 282, respectively. The MCU 270 controls the current information to be output to the DACs 281 and 282 based on the optical powers indicated by the optical power information output from the ADCs 261 and 262. For example, the MCU 270 controls the current information to be output to the DACs 281 and 282 such that the difference between the optical powers indicated by the optical power information is reduced.

The DACs 281 and 282 convert the digital current signals output from the MCU 270 to analog currents and applies the converted currents to the bases of the transistors 161 and 162, respectively. Thus, the currents fed from the transistors 161 and 162 to the diodes 141 and 142, respectively, may be controlled to control the phase shift amounts of the light beams in the diodes 141 and 142.

In the example illustrated in FIG. 2, the high-speed phase shifter 211 and the diode 141 are provided in the order in the parallel waveguide 121, for example, from the previous stage. However, the order may be changed. Also, the high-speed phase shifter 212 and the diode 142 are provided in the order in the parallel waveguide 122 from the previous stage. However, the order may be changed.

### Phase Modulation by Diodes according to Embodiment

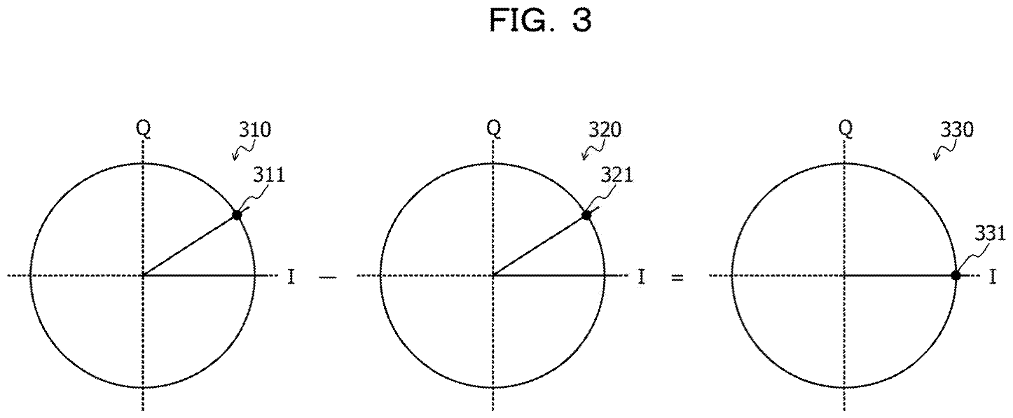

FIG. 3 is a diagram illustrating an example of phase modulation by the diodes according to the embodiment. As described above, the diodes 141 and 142 perform phase modulation on light by using changes of the refractive indices of the diodes 141 and 142 due to the carrier plasma effect.

For example, to feed currents of a predetermined value or higher to the diodes 141 and 142 at all times, the control unit 150 controls such that the forward-direction voltages of the diodes 141 and 142 are not lower than a threshold value voltage Vf. It is assumed that the currents flowing in the diodes 141 and 142 are offset currents when the forward-direction voltages of the diodes 141 and 142 are equal to the threshold value voltage Vf.

With reference to FIG. 3, cases where an offset current is fed to the diodes 141 and 142 will be described. A signal point 311 in a signal space diagram 310 indicates a change to be given to light by the diode 141 when the offset current is fed to the diode 141. A signal point 321 in a signal space diagram 320 indicates a change to be given to light by the diode 142 when the offset current is fed to the diode 142.

A signal point 331 in a signal space diagram 330 indicates a difference between the changes of light indicated by the signal points 311 and 321. As in the example illustrated in FIG. 3, when the offset current is fed to the diodes 141 and 142, equal phase shift amounts are produced in the diodes 141 and 142. Therefore, the phase difference to be given by the diodes 141 and 142 to the light beams passing through the parallel waveguides 121 and 122 (arms) is equal to zero.

### Another Example of Phase Modulation by Diodes According to Embodiment

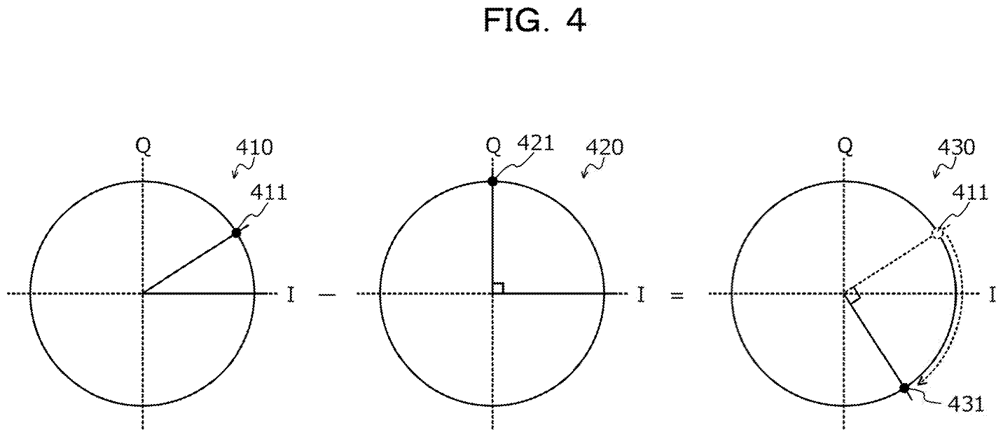

FIG. 4 is a diagram illustrating another example of phase modulation by the diodes according to the embodiment. With reference to FIG. 4, a case will be described where the offset current is fed to the diode 141 and a current higher than the offset current is fed to the diode 142.

A signal point 411 in a signal space diagram 410 indicates a change to be given to light by the diode 141 when the offset current is fed to the diode 141. A signal point 421 in a signal space diagram 420 indicates a change to be given to light by the diode 142 when a current higher than the offset current is fed to the diode 142. In the example illustrated in FIG. 4, the signal point 421 indicates a phase change of +90 degrees.

A signal point 431 in a signal space diagram 430 indicates a difference between the changes of light indicated by the signal points 411 and 421. As in the example illustrated in FIG. 4, in a case where the offset current is fed to the diode 141 and a current higher than the offset current is fed to the diode 142, the phase shift amounts in the diodes 141 and 142 differ.

Therefore, the phase difference to be given by the diodes 141 and 142 to the light beams passing through the parallel waveguides 121 and 122 is a phase difference that is different from zero. In the example illustrated in FIG. 4, because the diode 142 gives a phase change of +90 degrees to the light, the signal point 431 is a signal point acquired by rotating the signal point 411 by 90 degrees in clockwise.

The control unit 150 sets currents to be applied to the transistors 161 and 162 such that the offset current is fed to the diodes 141 and 142, as in the example illustrated in FIG. 3, at an initial state, for example. In order to hold the modulation operating point in the optical modulator 100, the control unit 150 controls the phase difference to be given by the diodes 141 and 142 by changing the currents to be applied to one of the transistors 161 and 162, for example. For example, the control unit 150 fixes the current to be applied to the upper side transistor 161 and changes the current to the applied to the lower side transistor 162 to control the phase difference to be given by the diodes 141 and 142.

### Decreases in Phase Shift Amount and Amplitudes Caused by Increase of Currents to be Fed to Diode

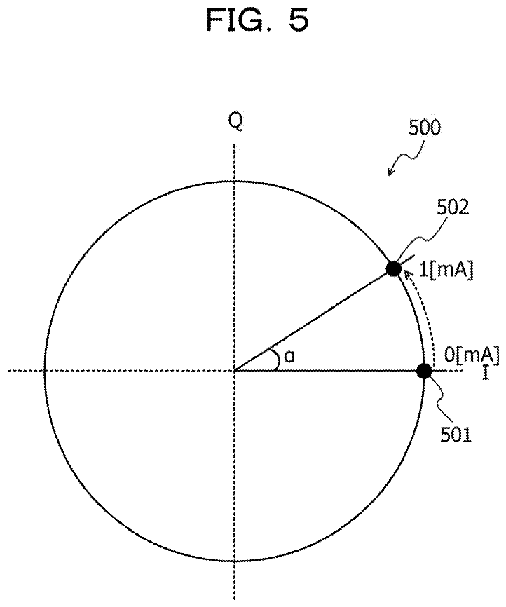

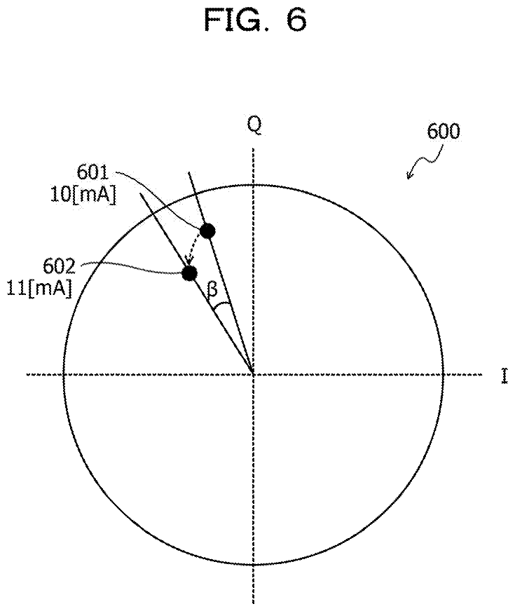

FIGS. 5 and 6 are diagrams illustrating an example of a decrease in phase shift amount and a decrease in amplitude caused by an increase of current to be fed to a diode. It is assumed that the unit change amount ΔI of current to be fed to the diode is 1 [mA].

Signal points 501 and 502 in a signal space diagram 500 illustrated in FIG. 5 indicate a change of light in a case where the currents flowing in the diode are 0 [mA] and 1 [mA]. As illustrated in FIG. 5, it is assumed that the phase shift amount (phase rotating amount) is α in a case where the current flowing in the diode is increased by the unit change amount ΔI from 0 [mA] to 1 [mA].

Signal points 601 and 602 in a signal space diagram 600 illustrated in FIG. 6 indicate a change of light in a case where the currents flowing in the diode are 10 [mA] and 11 [mA]. Assuming that the phase shift amount is β in a case where the current flowing in the diode is increased by the unit change amount ΔI from 10 [mA] to 11 [mA] as illustrated in FIG. 6, the phase shift amount β is smaller than the phase shift amount α.

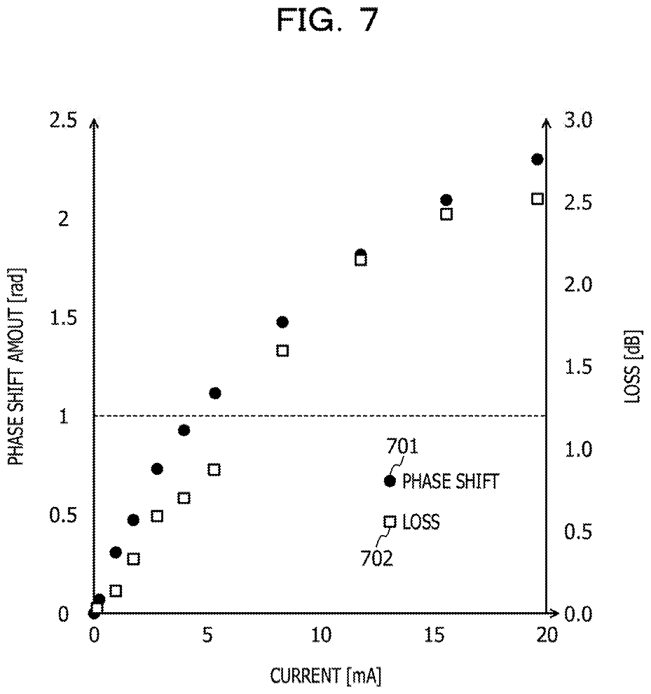

In this way, in the phase modulation using the carrier plasma effect, the change amount Δϕ of the phase shift amount against the unit change amount ΔI of the current flowing in the diodes decreases as the current flowing in the diode increases (see FIG. 7). Therefore, when the phase rotation amount is increased to move the modulation operating point in accordance with an environmental change or an aged deterioration, for example, the current flowing in the diode is increased so that the power (power consumption) required for the phase modulation is increased.

The amplitudes of the signal points 601 and 602 illustrated in FIG. 6 are smaller (or closer to the origin) than those of the signal points 501 and 502 illustrated in FIG. 5. The amount of the decrease of the amplitude in the transition from the signal point 601 to the signal point 602 is larger than the amount of the decrease of the amplitude in the transition from the signal point 501 to the signal point 502.

In this way, as the current flowing in the diode increases, the optical power loss increases because of an increase of optical absorption in the diode (see FIG. 7), and the amplitudes of the optical signals decrease. Therefore, when the phase rotation amount is increased to move the modulation operating point in accordance with an environmental change or an aged deterioration, for example, the power required for driving the light source increases because the output power of the light source is required to increase.

### Relationship between Current Flowing in Diode and Phase Shift amounts and Optical Losses

FIG. 7 is a graph illustrating an example of a relationship between current flowing in a diode and phase shift amounts and optical losses. FIG. 7 has a horizontal axis indicating current [mA] flowing in a diode and a left vertical axis and a right vertical axis indicating a phase shift amount [rad] of light passing through the diode and a loss [dB] of the light passing through the diode, respectively.

A plot group 701 indicates phase shift amounts of light passing through the diode against the amounts of current flowing in the diode. As indicated by the plot group 701, the change amount Δϕ of the phase shift amount against the unit change amount ΔI of the current flowing in the diode decreases as the current flowing in the diode increases.

A plot group 702 indicates losses of light passing through the diode against the amounts of current flowing in the diode. As indicated by the plot group 702, as the current flowing in the diode increases, the optical power loss increases because of an increase of optical absorption in the diode.

### Operation of Optical Modulator according to Embodiment

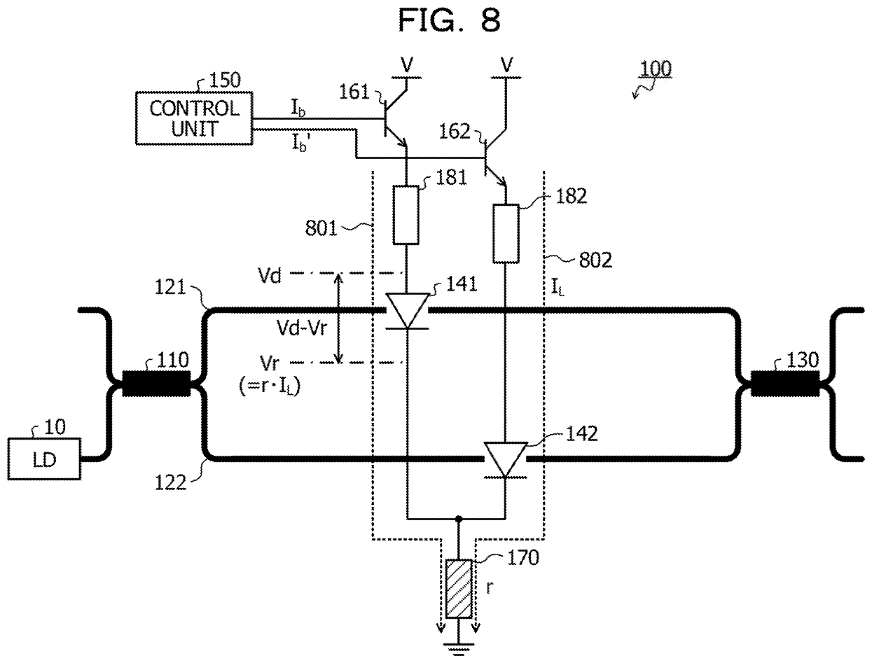

FIG. 8 is a diagram illustrating an example of an operation of the optical modulator according to the embodiment; In FIG. 8, the same portions as those illustrated in FIG. 1 are denoted by the same reference signs and descriptions thereof will be omitted. It is assumed that the current to be applied to the base of the upper side transistor 161 by the control unit 150 is a current I_{b} and that the current to be applied to the base of the lower side transistor 162 by the control unit 150 is a current I_{b}′. A case will be described that the control unit 150 fixes the current I_{b} and adjusts the current I_{b}′ to control the phase difference.

For example, the control unit 150 fixes the upper side, current I_{b} to I_{offset}. The I_{offset} is a current to be fed to the transistor 161 to feed the offset current to the diode 141 in a configuration without the phase adjustment resistance 170, for example. The control unit 150 adjusts the lower side current I_{b}′ in a range equal to or higher than the current I_{b}.

An upper side current 801 is a current flowing in the diode 141 when the control unit 150 applies the current I_{b} to the transistor 161. A lower side current 802 is a current flowing in the diode 142 when the control unit 150 applies the current I_{b}′ to the transistor 162. It is assumed that a potential between the detection resistance 181 and the diode 141 is Vd. When the emitter potential of the transistor 161 is Ve and the potential difference across the detection resistance 181 is VR, Vd=Ve−VR.

Because the phase adjustment resistance 170 (with a resistance value of r) is coupled to the cathodes of the diodes 141 and 142, the lower side current 802 (with a current value of I_{L}) flows into the phase adjustment resistance 170, and a voltage Vr=r*I_{L} is generated.

When the forward direction threshold voltage Vf is applied to a diode, current flows in the diode. Therefore, when the potential difference Vd−Vr across the diode 141 is in a range satisfying Vd−Vr≥Vf, current flows in the diode 141. On the other hand, when the lower side current 802 increases, the voltage Vr increases, resulting in Vd−Vr<Vf. Therefore, the upper side current 801 decreases. A further increase of the lower side current 802 results in Vd−Vr=0. Therefore, the upper side current 801 does not flow.

In other words, for example, as the current I_{b}′ is increased by the control unit 150, the lower side current 802 increases. However, at the same time, because of the effect of the phase adjustment resistance 170, the upper side current 801 decreases. Therefore, when the control unit 150 fixes the current I_{b} to be applied to the transistor 161 and changes the current I_{b}′ to be applied to the transistor 162, the upper side current 801 and the lower side current 802 may be changed in the opposite directions against each other.

### Current Flowing in Diodes of Optical Modulator according to Embodiment

FIG. 9 is a graph illustrating an example of currents flowing in diodes in the optical modulator according to the embodiment; In the example illustrated in FIG. 9, the control unit 150 fixes the current I_{b} to be applied to the upper side transistor 161 and changes the current I_{b}′ to be applied to the lower side transistor 162.

FIG. 9 has a horizontal axis indicating current (I_{b}′ above) applied to the base of the lower side transistor 162 and a vertical axis indicating current flowing in the diodes 141 and 142. The current flowing in the diodes 141 and 142 is a current detected by using the detection resistances 181 and 182, for example.

A voltage-current characteristic 901 indicates changes of the lower side current 802 flowing in the lower side diode 142 against changes of the current applied to the base of the lower side transistor 162. When the current applied to the base of the transistor 162 increases, the lower side current 802 flowing in the diode 142 increases.

For reference, a voltage-current characteristic 902 indicates changes of the upper side current 801 flowing in the upper side diode 141 against changes of the current applied to the base of the lower side transistor 162 when the phase adjustment resistance 170 is not provided. In a case where the phase adjustment resistance 170 is not provided, even when the current applied to the base of the transistor 162 increases, the upper side current 801 flowing in the diode 141 does not change.

A voltage-current characteristic 903 indicates changes of the upper side current 801 flowing in the upper side diode 141 against changes of the current applied to the base of the lower side transistor 162 when the phase adjustment resistance 170 is provided. Because of the provided phase adjustment resistance 170, when the current applied to the base of the transistor 162 increases, the upper side current 801 flowing in the diode 141 decreases.

### Phase Shift Amounts Given To Light Beams by the Diodes in Optical Modulator according to Embodiment

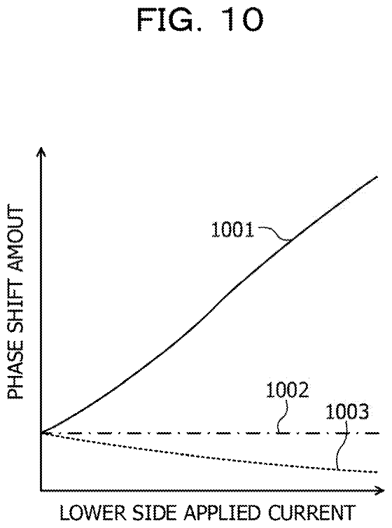

FIG. 10 is a graph illustrating an example of phase shift amounts given to the light beams by the diodes in the optical modulator according to the embodiment. With reference to FIG. 10, phase shift amounts to be given to light beams by the diodes 141 and 142 corresponding to the voltage-current characteristics 901 and 902 illustrated in FIG. 9 will be described. FIG. 10 has a horizontal axis indicating current applied to the base of the lower side transistor 162 and a vertical axis indicating phase shift amounts to be given to, light beams by the diodes 141 and 142.

A voltage-phase shift amount characteristic 1001 indicates changes of the phase shift amount given to the light beam by the lower side diode 142 against changes of the current applied to the base of the lower side transistor 162. When the current applied to the base of the transistor 162 increases, the lower side current 802 flowing in the diode 142 increases (voltage-current characteristic 901 in FIG. 9). Therefore, the phase shift amount given to the light beam by the diode 142 increases.

For reference, a voltage-phase shift amount characteristic 1002 indicates changes of the phase shift amount given to the light beam by the upper side diode 141 against changes of the current applied to the base of the lower side transistor 162 when the phase adjustment resistance 170 is not provided. In a case where the phase adjustment resistance 170 is not provided, even when the current applied to the base of the transistor 162 increases, the upper side current 801 flowing in the diode 141 does not change (the voltage-current characteristic 902 in FIG. 9). Therefore, the phase shift amount given to the light beam by the diode 141 does not change.

A voltage-phase shift amount characteristic 1003 indicates changes of the phase shift amount given to the light beam by the upper side diode 141 against changes of the current applied to the base of the lower side transistor 162 when the phase adjustment resistance 170 is provided. When the current applied to the base of the transistor 162 increases, the upper side current 801 flowing in the diode 141 decreases (voltage-current characteristic 903 in FIG. 9). Therefore, the phase shift amount given to the light beam by the diode 141 decreases.

### Phase Difference Given To Light Beams by Diodes in Optical Modulator according to Embodiment

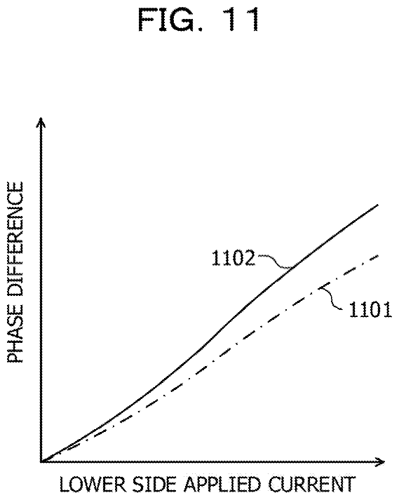

FIG. 11 is a graph illustrating an example of phase differences given to the light beams by the diodes in the optical modulator according to the embodiment; With reference to FIG. 11, phase differences given to the light beams by the diodes 141 and 142 corresponding to the voltage-phase shift amount characteristics 1001 and 1002 illustrated in FIG. 10 will be described. FIG. 11 has a horizontal axis indicating current applied to the base of the lower side transistor 162 and a vertical axis indicating phase differences given to the light beams by the diodes 141 and 142.

For reference, a voltage-phase difference characteristic 1101 indicates changes of the phase difference given to the light beams by the diodes 141 and 142 against changes of the current applied to the base of the lower side transistor 162 when the phase adjustment resistance 170 is not provided. In other words, for example, the voltage-phase difference characteristic 1101 indicates a difference between the voltage-phase shift amount characteristics 1001 and 1002 illustrated in FIG. 10 for reference.

A voltage-phase difference characteristic 1102 indicates changes of the phase difference given to the light beams by the diodes 141 and 142 against changes of the current applied to the base of the lower side transistor 162 when the phase adjustment resistance 170 is provided. In other words, for example, the voltage-phase difference characteristic 1102 indicates a difference between the voltage-phase shift amount characteristics 1001 and 1003 illustrated in FIG. 10.

As indicated by the voltage-phase difference characteristics 1101 and 1102, because of the provided phase adjustment resistance 170, changes of the phase difference given to the light beams by the diodes 141 and 142 may be increased against changes of the current applied to the base of the transistor 162. In other words, for example, the changes of the current applied to the transistor 162, which is required for acquiring a desired phase difference, may be reduced. Thus, the increase of the current applied to the transistor 162 may be suppressed, and the power required for the phase modulation may be reduced.

The suppression of the increase of the current applied to the transistor 162 allows suppression of the increase of current flowing in the diode 142 so that the optical absorption in the diode 142 may be reduced and the optical power loss may be reduced. Thus, because the increase of the output power of the LD 10 may be suppressed, the power required for driving the LD 10 may be reduced.

Having described the configuration in which the current to be applied to the upper side transistor 161 is fixed and the current to be applied to the lower side transistor 162 is changed, embodiments are not limited to such a configuration. Also with the configuration in which the current to be applied to the lower side transistor 162 is fixed and the current to be applied to the upper side transistor 161 is changed, for example, the power required for the phase modulation and the power required for driving the LD 10 may be reduced.

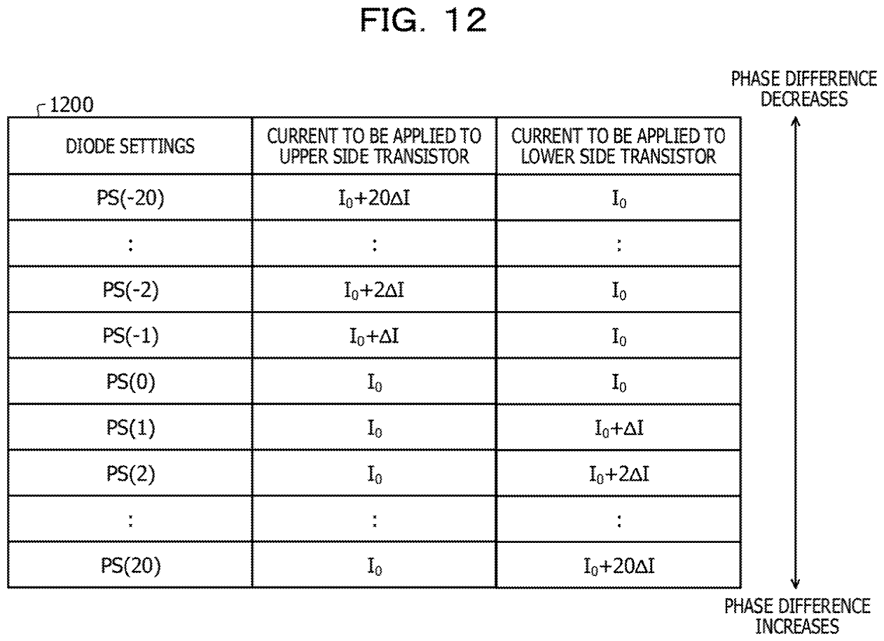

The control unit 150 may perform switching between the state that the current to be applied to the transistor 161 is fixed and the current to be applied to the transistor 162 is changed and the state that the current to be applied to the transistor 162 is fixed and the current to be applied to the transistor 161 is changed. A control of the control unit 150 that performs the switching will be described with reference to FIG. 12.

### Diode Settings by Optical Modulator according to Embodiment

FIG. 12 is a diagram illustrating examples of diode settings by the optical modulator according to the embodiment. A table 1200 illustrated in FIG. 12 illustrates settings to be defined for the diodes 141 and 142 by the control unit 150 (MCU 270) in the optical modulator 100 through the transistors 161 and 162.

The diode settings PS(−20) to PS(20) in the table 1200 are settings for the currents to be applied to the transistors 161 and 162 with phase differences in steps of one to be given by the diodes 141 and 142 to the light beams passing through the parallel waveguides 121 and 122. The “Current to be Applied to the Upper Side Transistor” in the table 1200 indicates the current to be applied to the transistor 161. The “Current to be Applied to the Lower Side Transistor” in the table 1200 indicates the current to be applied to the transistor 162.

The control unit 150 selects one of the diode settings PS(−20) to P5(20) for controlling the diodes 141 and 142. The control unit 150 outputs, to the DAC 281, current information indicating the current to be applied to the upper side transistor corresponding to the selected diode setting. The control unit 150 outputs, to the DAC 282, current information indicating the current to be applied to the lower side transistor corresponding to the selected diode setting.

For example, the diode setting PS(0) is a reference setting for defining the current to be applied to the transistors 161 and 162 to I₀. I₀ is a current value for applying the current Io to the transistors 161 and 162 so that the aforementioned offset current flows in the diodes 141 and 142.

The diode setting PS(1) is a setting for giving a phase difference increased by one step from the diode setting PS(0) to the light beams by the diodes 141 and 142. For example, the diode setting PS(1) is a setting for defining the current to be applied to the transistor 162 as I₀+ΔI and defining the current to be applied to the transistor 161 as Io.

The diode setting PS(2) is a setting for giving a phase difference increased by one step from the diode setting PS(1) to the light beams by the diodes 141 and 142. For example, the diode setting PS(2) is a setting for defining the current to be applied to the transistor 162 as I₀+2ΔI and defining the current to be applied to the transistor 161 as I₀. In this way, the diode settings PS(1) to PS(20) are settings that increase, by ΔI, the current to be applied to the transistor 162 with respect to the reference diode setting PS(0).

The diode setting PS(−1) is a setting for giving a phase difference reduced by one step from the diode setting PS(0) to the light beams by the diodes 141 and 142. For example, the diode setting PS(−1) is a setting for defining the current to be applied to the transistor 162 as Io and defining the current to be applied to the transistor 161 as I₀+ΔI.

The diode setting PS(−2) is a setting for giving a phase difference reduced by one step from the diode setting PS(−1) to the light beams by the diodes 141 and 142. For example, the diode setting PS(−2) is a setting for defining the current to be applied to the transistor 162 as I₀ and defining the current to be applied to the transistor 161 as I₀+2ΔI. In this way, the diode settings PS(−1) to PS(−20) are settings that increase, by ΔI, the current to be applied to the transistor 161 with respect to the reference diode setting PS(0).

As illustrated in FIG. 12, the phase difference to be given by the diodes 141 and 142 to the light beams passing through the parallel waveguides 121 and 122 may be increased or reduced by changing the current to be applied to one of the transistors 161 and 162.

### Control Step-Current Characteristic for Each Resistance Value of Phase Adjustment Resistance According to Embodiment

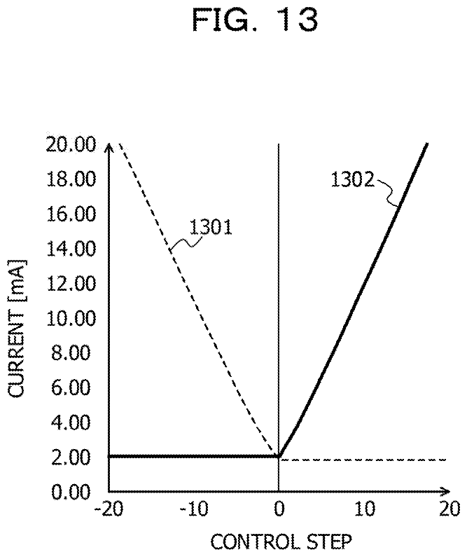

FIGS. 13 to 16 are graphs illustrating examples of a control step-current characteristic for each resistance value of the phase adjustment resistance according to the embodiment. In the examples illustrated in FIGS. 13 to 16, the aforementioned offset current is about 2 [mA]. Each of FIGS. 13 to 16 has a horizontal axis indicating control steps for the aforementioned diode settings and a vertical axis indicating current [mA] flowing in the diodes 141 and 142. The control steps for the diode settings are the diode settings PS(−20) to PS(20) illustrated in FIG. 12, for example.

For example, the range equal to or higher than “0” of the control steps corresponds to PS(0) to PS(20) illustrated in FIG. 12. In this range, the control unit 150 fixes the current to be, applied to the transistor 161 to the aforementioned current I₀ and controls the current to be applied to the transistor 162 in a range equal to or higher than I₀.

The range lower than “0” of the control steps corresponds to PS(−20) to PS(−1) illustrated in FIG. 12. In this range, the control unit 150 fixes the current to be applied to the transistor 162 to the aforementioned current Io and controls the current to be applied to the transistor 161 in a range equal to or higher than I₀.

A control step-current characteristic 1301 illustrated in FIGS. 13 to 16 indicates changes of current flowing in the upper side diode 141 against changes of the control step of the diode settings. A control step-current characteristic 1302 indicates changes of current flowing in the lower side diode 142 against changes of the control step of the diode settings.

FIG. 13 illustrates the control step-current characteristics 1301 and 1302 for reference when the phase adjustment resistance 170 is not provided (or when the phase adjustment resistance 170 has a resistance value of r=0 [Ω]). In the range equal to or higher than the control step “0” in the example illustrated in FIG. 13, the current flowing in the upper side diode 141 is fixed to 2 [mA] that is the offset current, and the current flowing in the lower side diode 142 changes. In the range lower than the control step “0”, the current flowing in the upper side diode 141 changes, and the current flowing in the lower side diode 142 is fixed to 2 [mA] that is the offset current.

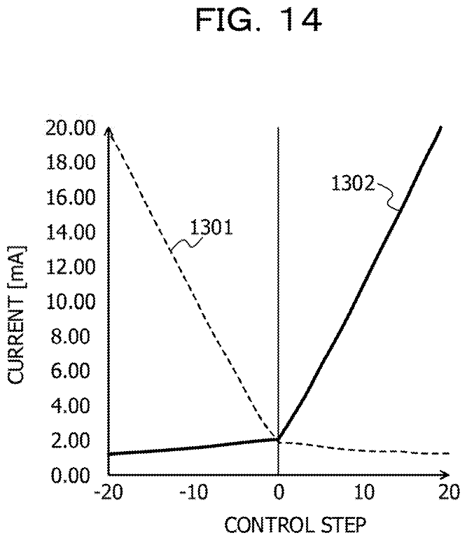

FIG. 14 illustrates control step-current characteristics 1301 and 1302 in the optical modulator 100 including the phase adjustment resistance 170 having a resistance value of r=6 [Ω]. In the range equal to or higher than the control step “0” in the example illustrated in FIG. 14, the current flowing in the upper side diode 141 decreases in accordance with the increases of the current flowing in the lower side diode 142. In the range lower than the control step “0”, the current flowing in the lower side diode 142 decreases in accordance with the increases of the current flowing in the upper side diode 141.

In this way, when the phase adjustment resistance 170 having a resistance value higher than 0 [Ω] is provided, the current flowing in the diode with fixed current applied to the upper side or lower side transistor changes in the opposite direction against that of the current flowing in the other diode. Thus, the change of the phase difference per unit change amount of the current to be applied to the transistors may be increased.

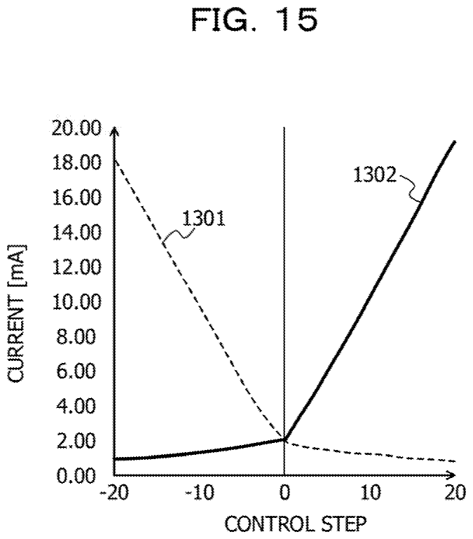

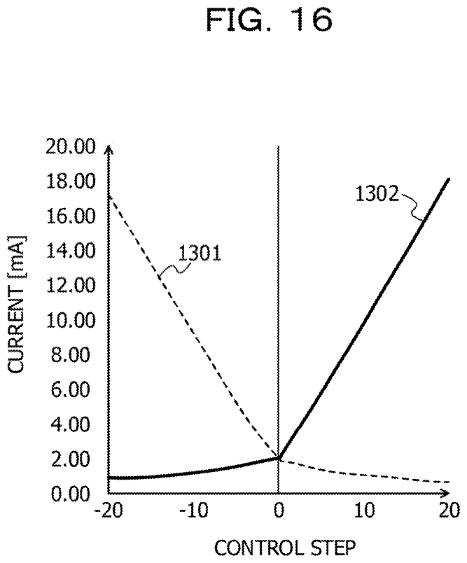

FIGS. 15 illustrates control step-current characteristics 1301 and 1302 in the optical modulator 100 including the phase adjustment resistance 170 having a resistance value of r=12 [Ω]. FIG. 16 illustrates control step-current characteristics 1301 and 1302 in the optical modulator 100 including the phase adjustment resistance 170 having a resistance value of r=18 [Ω].

As illustrated in FIGS. 14 to 16, as the resistance value r of the phase adjustment resistance 170 increases, the change of the current flowing in the upper side or lower side diode with the transistor to which fixed current is applied increases (or the change of the phase difference increases). In other words, for example, as the resistance value r of the phase adjustment resistance 170 increases, the aforementioned power may be suppressed.

However, when the resistance value r of the phase adjustment resistance 170 is excessively increased, the change of the phase difference given to the light beams becomes rapid. For example, during a state transition in the optical modulator 100, there is a risk that the phase difference given to the light beams are largely deviated from a target value. Therefore, the resistance value r of the phase adjustment resistance 170 is determined based on the performance of the control unit 150 (such as the MCU 270) in the optical modulator 100, the operating environment of the optical modulator 100, a required power consumption performance, and so on.

The phase adjustment resistance 170 may be a variable resistance with a resistance value r that is adjustable under control of the MCU 270, for example. Thus, the resistance value r of the phase adjustment resistance 170 may be changed in accordance with changes of the operating environment of the optical modulator 100 and the required power consumption performance.

In this way, the optical modulator 100 according to this embodiment includes the phase adjustment resistance 170 having one end coupled to the diodes 141 and 142 and the other end grounded. Thus, when a current value of the current flowing in one of the diodes is changed, the current value of the current flowing in the other diode changes in the opposite direction, The differences of the phase shift amounts in the diodes may be largely changed. Therefore, because small current changes may result in a large phase difference, the power required for the phase modulation may be reduced.

Because the amounts of current flowing in the diodes 141 and 142 may be reduced, the optical absorption in the diodes 141 and 142 may be reduced, and the optical power loss may be reduced. Thus, because the increase of the output power of the light source may be suppressed, the power required for driving the power source may be reduced.

The control may be simplified compared with a configuration, for example, that changes the currents flowing in the diodes 141 and 142 in opposite directions by controlling the currents applied to the transistors 161 and 162 in the opposite directions against each other to acquire a large phase difference.

For example, as illustrated in FIGS. 13 to 16, because the amount of current change per unit control step is different between a region with a current equal to or higher than the offset current and a region with current lower than the offset current, a complicated control is performed for changing the currents applied to the transistors 161 and 162 in the opposite directions against each other. For example, because different control steps are required for the currents applied to the transistors 161 and 162, a complex algorithm or hardware is used.

On the other hand, in the optical modulator 100 that changes the currents flowing in the diodes 141 and 142 in the opposite directions with the phase adjustment resistance 170, a simple control may be performed that changes one of the currents applied to the transistors 161 and 162 Thus, the power consumption may be reduced even without using a complicated algorithm or hardware.

However, the phase adjustment resistance 170 may be provided in the configuration that, for example, controls the currents applied to the transistors 161 and 162 in the opposite directions against each other. In this case, the currents flowing in the diodes 141 and 142 are changed in the opposite directions by controlling the currents applied to the transistor 161 and 162 in the opposite directions against each other, and the changes in the opposite directions may be further increased by the phase adjustment resistance 170. Because a large phase difference may be acquired with small changes of currents, the power consumption may be reduced,

Having described the configuration using the diodes 141 and 142 as phase shifters that shift phases of light beams in accordance with the currents flowing therein, the phase shifters may not be the diodes 141 and 142. Any phase shifters may be used that shift phases of light beams in accordance with currents flowing therein. In other words, for example, the optical modulator 100 may include phase shifters that shift phases of light beams in accordance with currents flowing therein, instead of the diodes 141 and 142.

Voltages to be applied to the diodes 141 and 142 may be fixed, and, at the same time, currents flowing in the diodes 141 and 142 may be adjusted. Thus, it may be suppressed that currents do not flow in the diodes 141 and 142 because of excessively low voltages applied to the diodes 141 and 142.

Having described the configuration using the transistors 161 and 162, which are bipolar transistors, for fixing the voltages to be applied to the diode 141 and 142 and adjusting the currents flowing in the diodes 141 and 142, embodiments are not limited to such a configuration. For example, a source follower circuit may be used that applies field effect transistors (FETs) as the transistors 161 and 162.

In this case, the drain of the transistor 161 is coupled to a voltage source V, and the source of the transistor 161 is coupled to the anode of the diode 141. The drain of the transistor 162 is coupled to the voltage source V, and the source of the transistor 162 is coupled to the anode of the diode 142. The control unit 150 controls the phase difference by adjusting the voltages to be applied to the gates of the transistors 161 and 162.

With the optical modulator and the optical module, as described above, power required for phase modulation may be reduced,

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An optical modulator comprising:
a first optical waveguide dividing light input thereto;
first and second diodes shifting phases of light beams as a result of the division of the light by the optical waveguide;
a second optical waveguide causing the light beams passing through the first and second diodes to interfere;
a control circuit adjusting at least one of a current flowing in the first diode and a current flowing in the second diode to control a phase difference of the light beams interfering in the second optical waveguide; and
an electrical resistance element having one end coupled to the first and second diodes and the other end grounded.

2. The optical modulator according to claim 1, wherein
the control circuit is coupled to anodes of the first and second diodes, and
the electrical resistance element is coupled to cathodes of the first and second diodes.

3. The optical modulator according to claim 1, wherein
the control circuit fixes voltages to be applied to the first and second diodes and adjusts at least one of a current flowing in the first diode and a current flowing in the second diode.

4. The optical modulator according to claim 3, wherein
the control circuit adjusts at least one of a current to be applied to a base of a bipolar transistor having a collector coupled to a voltage source and an emitter coupled to the first diode and a current to be applied to a base of a bipolar transistor having a collector coupled to the voltage source and an emitter coupled to the second diode.

5. The optical modulator according to claim 3, wherein
the control circuit adjusts at least one of a voltage to be applied to a gate of a field effect transistor having a drain coupled to the voltage source and a source coupled to the first diode and a voltage to be applied to a gate of a field effect transistor having a drain coupled to the voltage source and a source coupled to the second diode.

6. The optical modulator according to claim 1, wherein
the control circuit corrects deviations from a predetermined value of a phase difference of the light beams interfering in the second optical waveguide by adjusting at least one of a current flowing in the first diode and a current flowing in the second diode based on a result of detection of power of light acquired by the interference of the light beams in the second optical waveguide.

7. The optical modulator according to claim 6, wherein
the control circuit adjusts at least one of a current flowing in the first diode and a current flowing in the second diode such that a difference between powers of light beams acquired by the interference of the light beams in the second optical waveguide is small.

8. The optical modulator according to claim 1, further comprising:
phase shifters performing phase-modulation on light beams interfering in the optical waveguide based on a data signal input thereto.

9. The optical modulator according to claim 1, wherein
the electrical resistance element has a variable resistance value.

10. An optical module comprising:
a light source outputting light;
an optical modulator having a first optical waveguide dividing light output by the light source, first and second diodes shifting phases of light beams as a result of the division in the first optical waveguide, and a second optical waveguide causing light beams passing through the first and second diodes to interfere;
a control circuit adjusting at least one of a current flowing in the first diode and a current flowing in the second diode to control a phase difference of the light beams interfering in the second optical waveguide; and
an electrical resistance element having one end coupled to the first and second diodes and the other end grounded.

11. The optical module according to claim 10, wherein
the control circuit is coupled to anodes of the first and second diodes, and
the electrical resistance element is coupled to cathodes of the first and second diodes.
